(19) United States
(12) Patent Application Publication
(10) Pub. No.: US 2018/0285860 A1
(43) Pub. Date: Oct. 4, 2018

(54) APPARATUS FOR PROCESSING A PURCHASE TRANSACTION

(71) Applicant: MASTERCARD ASIA/PACIFIC PTE. LTD., Singapore (SG)

(72) Inventors: Rajen Prabhu, Singapore (SG); Monica Jasuja, New Delhi (IN)

(73) Assignee: MASTERCARD ASIA/PACIFIC PTE. LTD., Singapore (SG)

(21) Appl. No.: 15/944,877

(22) Filed: Apr. 4, 2018

(30) Foreign Application Priority Data
Apr. 4, 2017 (SG) 10201702772X

(51) Int. Cl. G06Q 20/34; G06Q 20/24; G06Q 20/32

(52) U.S. Cl. CPC G06Q 20/34; G06Q 20/325; G06Q 20/24

(57) ABSTRACT

Disclosed is an apparatus for processing a purchase transaction. The apparatus comprises at least one processor and at least one memory including computer program code. The at least one memory and the computer program code are configured to, with the at least one processor, cause the apparatus at least to receive, from a client terminal, data representing a basket for purchase, and a creation request to create a payment vehicle for initiating the purchase transaction based on the data representing the basket. The at least one memory and at least one processor also cause the apparatus to receive (i) unique consumer identification information of a consumer purchasing the basket, (ii) a transaction value of the basket, and (iii) the creation request, and determine whether the consumer is authorized to be issued a payment vehicle based at least on the unique consumer identification information. In response to a determination that the consumer is so authorized, the payment vehicle is created in response to the creation request and has an available balance equal to or higher than the transaction value. The purchase transaction is then processed using the payment vehicle

### CROSS-REFERENCE TO RELATED APPLICATIONS

This application claims the priority benefit of Singapore Application Serial No. 10201702772X, filed Apr. 4, 2017, which is incorporated herein by reference in its entirety.

### FIELD

The present disclosure relates broadly, but not exclusively, to an apparatus for processing a purchase transaction, and a computer process performed on that apparatus.

### BACKGROUND

Payment networks are increasingly accessed using credit cards which, in recent years, have become one of the most popular payment vehicles. For example, a recent survey done by HSBC in 2012 noted that every person in Singapore owns an average of 3.3 credit cards, the highest in Asia. Though credit card usage is becoming increasingly popular, barriers to getting a credit card issued for potential card-holders continue to exist. The barriers may persist even in cases where credit worthiness of an individual has been established over a period of time through repayment of transactions settled using credit.

Online purchases performed through e-commerce platforms or mobile applications (for example, merchant-operated mobile apps or merchant aggregator apps such as GrubHub or Deliveroo) often require payment to be made with a credit card or other type of payment card. As such, the entry barrier for credit card issuance may hinder e-commerce growth, posing an unnecessary obstacle in achieving efficiency in the e-commerce transaction process.

An alternative to payment on some e-commerce platforms or via an app may be Cash on Delivery (COD). Nevertheless, this may also not be an efficient option. For example, from a merchant's point of view, COD is time-consuming and expensive since the merchant does not receive payment at the point of sale and is only paid upon delivery of goods. Moreover, the merchant carries unnecessary risk that the consumer may cancel the sale in the midst of the transaction without paying any compensation for the cancelled transaction. Furthermore, the merchant will be loaded with cash after delivery, which may pose a risk of theft for the merchant.

From the consumer's viewpoint, there may exist at least an artificial cap for a transaction amount in a COD transaction since cash is involved. Moreover, the consumer is also required to be present for the transaction since payment and goods are exchanged only at the point of delivery. These factors cause unnecessary inefficiency for an e-commerce marketplace and much inconvenience for both consumers and merchants.

In view of the above, it would be desirable to provide a computer apparatus implementing a computer process for processing a purchase transaction which overcomes one or more of the above disadvantages, or at least provides a useful alternative.

### SUMMARY

The present disclosure provides an apparatus for processing a purchase transaction, the apparatus comprising:

at least one processor; and

at least one memory including computer program code;

the at least one memory and the computer program code configured to, with the at least one processor, cause the apparatus at least to:

receive, from a client terminal:
data representing a basket for purchase; and
a creation request to create a payment vehicle for initiating the purchase transaction based on the data representing the basket;

receive:
unique consumer identification information of a consumer purchasing the basket;
a transaction value of the basket; and
the creation request;

determine whether the consumer is authorized to be issued a payment vehicle based at least on the unique consumer identification information and, in response to a determination that the consumer is so authorized, create the payment vehicle in response to the creation request, the payment vehicle having an available balance equal to or higher than the transaction value; and

process the purchase transaction using the payment vehicle.

The present disclosure further provides a computer process for accessing funds for a purchase transaction, comprising:

receiving, from a client terminal, at a merchant server:
data representing a basket for purchase; and
a creation request to create a payment vehicle for initiating the purchase transaction to purchase the basket;

receiving, at a payment transaction server:
unique consumer identification information of a consumer purchasing the basket;
a transaction value of the basket; and
the creation request;

determining, at the payment transaction server, whether the consumer is authorized to be issued a payment vehicle based at least on the unique consumer identification information and, in response to a determination that the consumer is so authorized, creating the payment vehicle in response to the creation request, the payment vehicle having an available balance equal to or higher than the transaction value; and

processing the purchase transaction using the payment vehicle.

The present disclosure further provides a computer-readable storage medium having stored thereon computer program code which when executed by a computer causes the computer to execute a process in accordance with the method described above.

The following terms will be given the meaning provided here, in the absence of context dictating use of a different meaning:

A “basket” refers to a group of items selected by a consumer for purchase in a purchase transaction. A unique basket may be formed for each purchase transaction. Alternatively, a basket may be saved such that the basket may be reuse for multiple purchase transactions.
“Transaction value” refers to a monetary amount for purchase of the basket. The transaction value may be sent to a payment transaction server as part of the transaction details of the purchase transaction. The transaction details may include other information such as one or more of a merchant identifier for identifying a merchant, a transaction identifier for identifying the transaction (e.g. an invoice or receipt number), and the date of the transaction.
“Processing a transaction” refers to performing a series of computational and/or telecommunications operations so as to facilitate completion of the transaction, the transaction being usually an electronically implemented commercial exchange between a consumer and a merchant.
“Processing a transaction using a payment vehicle” will be understood by the skilled person in the art to mean that payment vehicle details (e.g. credit or debit card number, payment token, expiry date, card verification value, etc) are used so that a transaction network can draw funds associated with the payment vehicle in order to process the transaction. Also, a transaction network can comprise any network capable of settling purchase transactions, such as the common four party merchant-acquirer-network-issuer (e.g. MasterCard, Visa or China UnionPay) or a three-party network (American Express or Discover Card).
“Electronic purchase medium” refers to e-commerce platforms and websites, mobile apps and other electronic media through which purchase transactions can be initiated. In general, for purchase transactions made through an electronic purchase medium the payment vehicle from which the payment vehicle details are derived need not be physically present at the time of the transaction. Such transactions may thus be referred to a “card-not-present transactions” and “a purchase transaction” will be understood to include, but not be limited to, card-not-present transactions made through any appropriate electronic purchase medium.
“Predetermined shopping profile” refers to a shopping profile of a consumer associated with an e-commerce platform, app or other mode of making card-not-present transactions, which satisfies at least one of a set of allowable criteria as set out by either a payment transaction server or an issuer server. The allowable criteria are criteria which dictate when a payment vehicle is allowed to be created. The allowable criteria may include a transaction history of making payment for purchases on the e-commerce platform, app or otherwise, using a credit facility (e.g. credit card, credit line) and making timely repayment of the used credit, or a good payment record for purchases using the Cash on Delivery (COD) payment option. A skilled person in the art would understand that a shopping profile “conforming to” a predetermined shopping profile conforms to at least one of the above allowable criteria.
“Predetermined expiry period” refers to a time period over which the created payment vehicle is valid, as determined by either a payment transaction server or an issuer server.

Furthermore, other desirable features and characteristics will become apparent from the subsequent detailed description and the appended claims, taken in conjunction with the accompanying drawings and this background of the disclosure.

### BRIEF DESCRIPTION OF THE DRAWINGS

Embodiments will now be presented, by way of non-limiting example only, with reference to the accompanying drawings in which:

FIG. 1 depicts a computer process for processing a purchase transaction in accordance with an embodiment.

FIG. 2 depicts a computer process for providing a payment vehicle issued at a time of sale to consumer whose shopping profile conforms to a predetermined shopping profile, in accordance with an embodiment.

FIG. 3, comprising FIGS. 3A, 3B and 3C, shows an example of performing a purchase transaction in accordance with an embodiment, wherein FIG. 3A depicts an alternative payment method on a payment screen of the purchase transaction; FIG. 3B depicts a sign-up screen for the alternative payment method; and FIG. 3C depicts a real-time issuance of a payment vehicle for the alternative payment method.

FIG. 4, comprising FIGS. 4A, 4B and 4C, shows an example of increasing an available balance of a payment vehicle of the alternative payment method in accordance with an embodiment.

FIG. 5 shows an example for making payment to a payment vehicle of the alternative payment method in accordance with an embodiment.

FIG. 6 shows examples for using the payment vehicle of the alternative payment method in accordance with an embodiment.

FIG. 7 depicts a block diagram of a system for processing a purchase transaction in accordance with an embodiment.

FIG. 8 depicts a schematic diagram of a computer system for executing the computer process of FIG. 1.

FIG. 9 depicts an exemplary computing device to realise a device 706 shown in FIG. 7.

### DETAILED DESCRIPTION

Embodiments of the present invention will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “receiving”, “determining”, “creating”, “sending”, “processing”, “completing”, “authorising”, “identifying”, “generating”, “associating” or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses an apparatus for performing the operations of the computer processes. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required process steps may be appropriate. The structure of a computer will appear from the description below.

In addition, the present specification also implicitly discloses a computer program, in that it would be apparent to the person skilled in the art that the individual steps of the process described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a general-purpose computer effectively results in an apparatus that implements the steps of the preferred process.

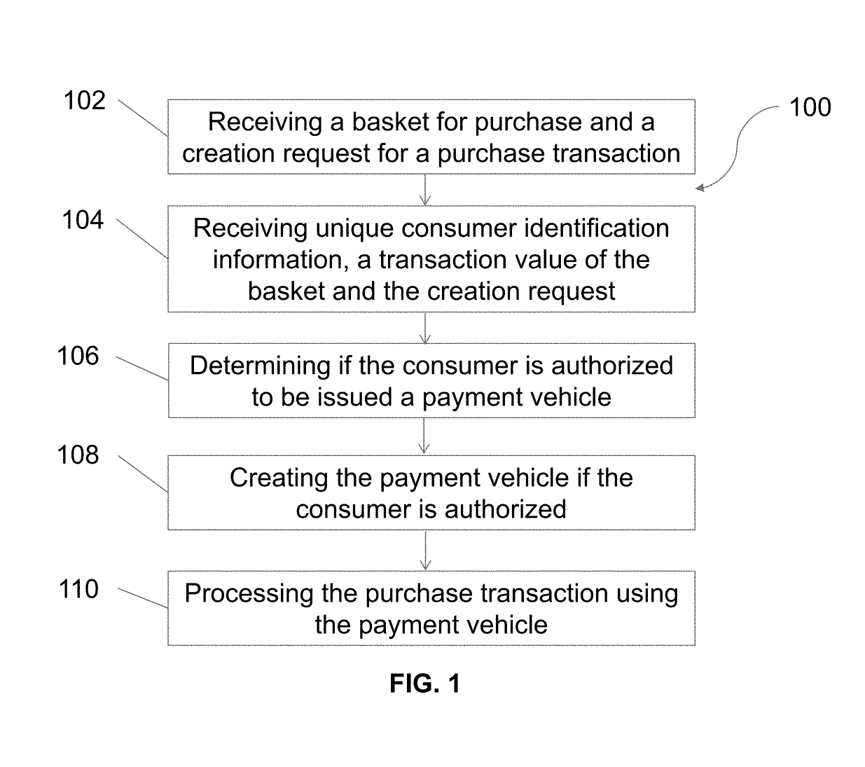

FIG. 1 shows a computer process 100, in accordance with certain embodiments, for processing a purchase transaction. The process 100 provides a payment vehicle for processing the purchase transaction, where that payment vehicle is issued at the time of sale or purchase. The payment vehicle may be one of a credit card, a debit card, a pre-paid card, a credit line or bank account.

The process 100 uses customer data gathered by card issuers, including purchase behaviour, information relating to payment instruments previously used by the purchaser, and credibility information (number and/or frequency of returns made, number and/or value of payments honoured etc.), to predict buying behaviour. The customer data can then be used for the issuance of payment vehicles to customers at the point of sale, thereby maximising efficiency in the e-commerce transaction marketplace or through app utilisation. This allows consumers to enjoy better convenience and purchase experience. For example, payment vehicles issued at the point of sale may advantageously allow the customer to take part in loyalty programmes offered by the e-commerce platform, app or payment vehicle issuer. Furthermore, customers may also enjoy easy accounting of their monthly expenditures since all relevant transactions may be captured in a monthly statement of the payment vehicle whereas COD transactions require retention of a receipt. Still furthermore, merchants can enjoy insurance in transactions since payment card issuers now act as intermediaries for the transactions to ensure that proper payments are made to the merchants. Merchants will also operate as acquirers by distributing new payment vehicles to consumers. Overall, the process 100 aids in improving efficiency of e-commerce transactions and users experience for consumers and merchants.

The process 100 broadly comprises the steps of:

Step 102: receiving data representing a basket for purchase (it will be appreciated that references to a “basket” equate, in a virtual/online setting, to information or data representing that basket) and a creation request for a purchase transaction;
Step 104: receiving unique consumer identification information, a transaction value of the basket and the creation request;
Step 106: determining if the consumer is authorized to be issued a payment vehicle;
Step 108: creating the payment vehicle if the consumer is so authorized; and
Step 110: processing the purchase transaction using the payment vehicle.

In step 102, data representing a basket for purchase (hereinafter the “basket”) and a creation request for a purchase transaction are received. The basket and the creation request are sent from a client terminal and received at a merchant server, the merchant server being associated with an electronic purchase medium on which the basket is created. The basket specifies or includes items desired to be purchased by a consumer in the purchase transaction. In embodiments, the basket is included as part of a transaction request received at the merchant server. The transaction request may further comprise at least consumer data identifying a consumer account and merchant data identifying a merchant account, the consumer account and the merchant account being hosted at the electronic purchase medium. The consumer account may include consumer information comprising the name of the consumer, a consumer delivery address, and any consumer payment card associated with the consumer account. The merchant account may include the name of the merchant, a merchant bank account number associated with a merchant bank, and goods associated with the merchant put on sale on the electronic purchase medium. In some embodiments, the transaction request indicates a time, a date at which the transaction request was initiated by the consumer and a desired delivery date for the basket for purchase. Variations on the data contained in the transaction request will be understood by the skilled person.

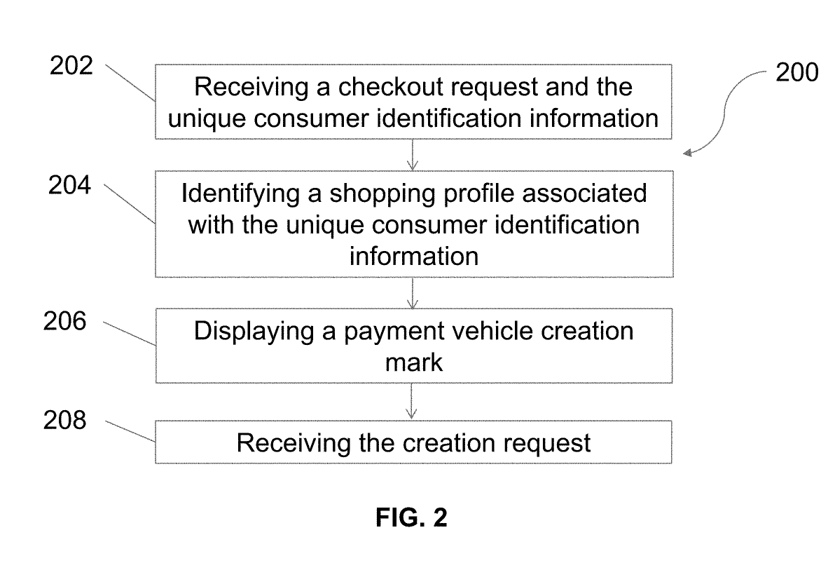

The creation request includes a request to create a payment vehicle for initiating the purchase transaction. The creation request can be made by selecting an option at a payment page at which the basket is purchased. This will be discussed in detail in FIG. 2 below. Once the basket for purchase is received together with the creation request in step 102 at the merchant server, the necessary information associated with the purchase transaction is forwarded to a payment transaction server.

In step 104, unique consumer identification information, a transaction value of the basket and the creation request is received at a payment transaction server. The unique consumer identification information is associated with the consumer purchasing the basket, and includes information by which the consumer can be uniquely identified. This may include a Social Security Number, national identification number such as a National Registration Identity Card (NRIC) Number (Singapore) or Aadhaar ID (India), or the like. The payment transaction server and/or the acquirer server may be able to determine a credit profile based on the unique consumer identification information. The unique consumer identification information may be received from the client terminal at the payment transaction server as part of the necessary information provided by the consumer when he/she made the creation request. The creation request may include other information such as an occupation and monthly income of the consumer. The transaction value of the basket may be received at the payment transaction server as part of the details embodied in the transaction request. Alternatively, the transaction value of the basket may be determined after the basket has been received at the merchant server.

Notably, steps 102 and 104 may be performed in sequence or concurrently, for example as a single step.

In step 106, it is determined if the consumer is authorized to be issued a payment vehicle. This determination is based at least on the unique consumer identification information. In an embodiment, in determining if the consumer is authorized to be issued the payment vehicle, it is determined at the payment transaction server, whether a financial history of the consumer conforms to an authorization profile. The authorization profile is a collection of one or more parameters that may include: the requirements or parameters that determined whether or not the consumer is authorized to be issued a payment vehicle—e.g. transaction frequency, minimum monthly spend, credit history—the maximum (or minimum) value of the payment vehicle, the period over which any used credit must be repaid, the interest rate applied to outstanding balances on the payment vehicle, fees associated with the payment vehicle, the expiry date of the payment vehicle and so on.

The financial history may be identified based on the unique consumer identification information, while the authorization profile may be a determined by the payment transaction server or the issuer server. The unique consumer identification information may be used to acquire a transaction history for the user, or the user's personal details (e.g. salary).

The financial history may relate to a credit history of repayments as well as mode of payments for past transactions associated with the consumer. In some embodiments, it is also determined at the payment transaction server, a maximum payment vehicle balance for which authorization can be given to issue the consumer a payment vehicle.

The payment transaction server may predetermine the authorization profiles (e.g. the requirements for a consumer to be issued a payment vehicle—e.g. transaction frequency, minimum monthly spend, credit history—the value of the payment vehicle authorized to be issued and so on) so that the authorization profile does not need to be generated at the time of purchase. Issuance of the payment vehicle to the consumer is then authorized in response to a determination that the financial history conforms to the authorization profile. For example, if the consumer's transaction history shows a minimum monthly spend above a certain threshold minimum spend specified in the authorization profile, then that criterion will be satisfied. If all other criteria are similarly satisfied (or a minimum number of those criteria) then there is conformance between the financial history and authorization profile.

In step 108, creation of the payment vehicle is authorised if determination step 106 confirms there is conformance between the consumer's financial history and the profile. In various embodiments, the payment vehicle is created in response to the creation request, where the payment vehicle has an available balance equal to or higher than the transaction value. A maximum payment vehicle balance may also be determined, the maximum balance being the maximum amount—for example the maximum amount of credit—for which authorization can be given under step 106 to issue a payment vehicle to the consumer. The payment vehicle may then only be issued if the maximum balance is equal to or higher than the transaction value. For embodiments where the payment vehicle is a credit card or credit facility, the payment vehicle may be created with the maximum payment vehicle balance as the available balance, where the maximum payment vehicle balance is equal to or higher than the transaction value. In some embodiments, where the payment vehicle authorized to be issued in step 106 comprises a pre-paid card or a stored value card, a top-up request to increase the available balance of the payment vehicle to equal to or higher than the transaction value is received from the client terminal, at the payment transaction server. In these embodiments, the creation of the payment vehicle comprises: sending a request from the payment transaction server to the client terminal requesting provision of a consumer specified payment vehicle balance to be greater than or equal to the transaction value and less than or equal to the maximum payment vehicle balance; receiving the consumer specified payment vehicle balance; and creating the payment vehicle with the consumer specified payment vehicle balance as the available balance. The top-up request may be performed using funds drawn from an account associated with the consumer. The payment vehicle with the increased available balance may then be created thereafter.

In step 110, the purchase transaction using the payment vehicle is processed. In various embodiments, processing the transaction comprises automatically processing the transaction upon creation of the payment vehicle based on the transaction value, the unique consumer identification information and the payment vehicle details (e.g. card number, expiry, CVV). In other embodiments, the transaction is not processed automatically. In these embodiments, after the creation of the payment vehicle in step 108, payment vehicle details associated with the payment vehicle are sent by the payment transaction server to the client terminal. A completion request, being a request to process the transaction using the newly issued payment vehicle, may then be received from the client terminal at the payment transaction server to complete the transaction using the payment vehicle. In various embodiments, a notification indicating that processing of the purchase transaction has been successful is sent to the client terminal after the transaction is completed using the payment vehicle.

FIG. 2 shows a computer process 200, in accordance with an embodiment of the invention, for providing a payment vehicle issued at a time of sale to consumer whose shopping profile conforms to the predetermined shopping profile. The process broadly comprises the steps of:

Step 202: Receiving a checkout request and the unique consumer identification information;
Step 204: Identifying a shopping profile associated with the unique consumer identification information;
Step 206: Displaying a payment vehicle creation mark; and
Step 208: Receiving the creation request.

In step 202, a checkout request and the unique consumer identification information are received at the merchant server. The checkout request includes the basket and other information relating to the transaction as discussed previously. The unique consumer identification information may include information relating to a consumer account associated with the electronic purchase medium at which the purchase transaction is to take place.

In step 204, a shopping profile associated with the unique consumer identification information is identified at the payment transaction server. This may involve using the unique consumer identification information to identify a relevant shopping profile at a database associated with the payment transaction server. The relevant shopping profile may comprise historical transaction data associated with the consumer and a credit/financial history of the consumer. The relevant shopping profile may also identify purchase behaviour of the consumer, including information as to whether the consumer prefers credit facility payment options or COD payment options. A relevant payment vehicle may then be issued to the consumer based on his/her shopping profile. In some embodiments, where the consumer has a bad credit history (e.g. a history of late payments for past purchases), the payment transaction server identifies the consumer to be not eligible for the payment vehicle issued at the point of sale. This consumer will be identified to have a shopping profile that does not conform to the predetermined shopping profile. In this case the payment vehicle creation mark may be deactivated for the duration of the transaction.

In step 206, a payment vehicle creation mark is displayed at the client terminal. In various embodiments, the payment vehicle creation mark is displayed only to consumer whose shopping profile conforms to the predetermined shopping profile. This will require the user to provide the unique consumer identification information to enable the transaction processing server to determine the consumer's shopping profile. In other embodiments, selection of the payment vehicle creation mark initiates determination of the consumer's shopping profile.

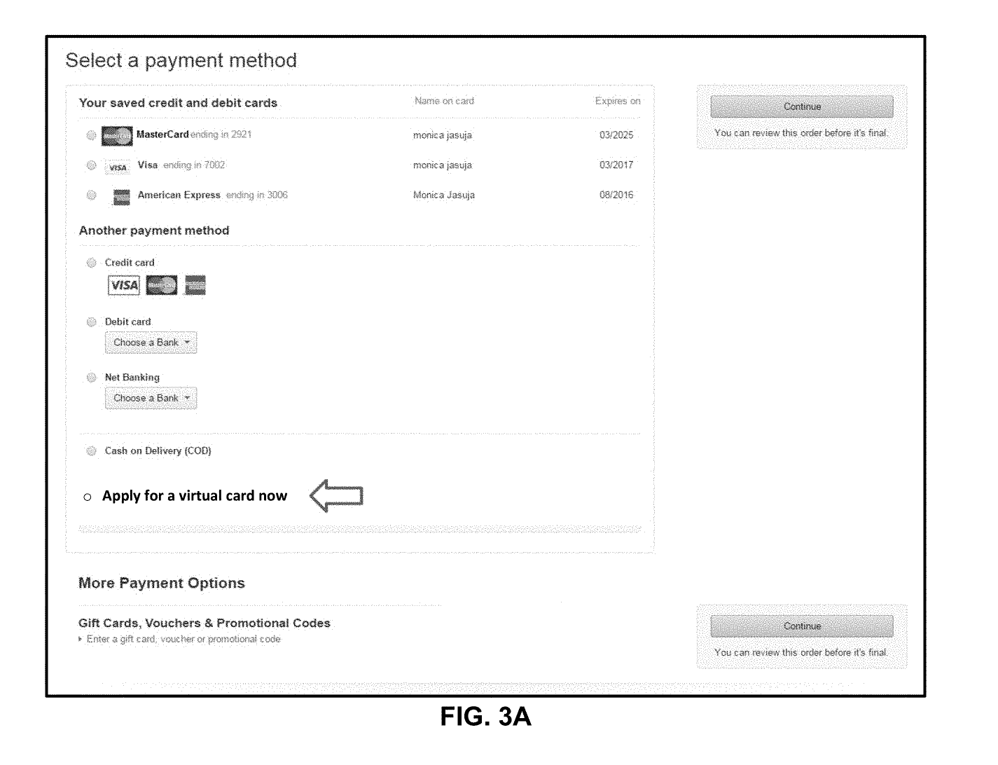

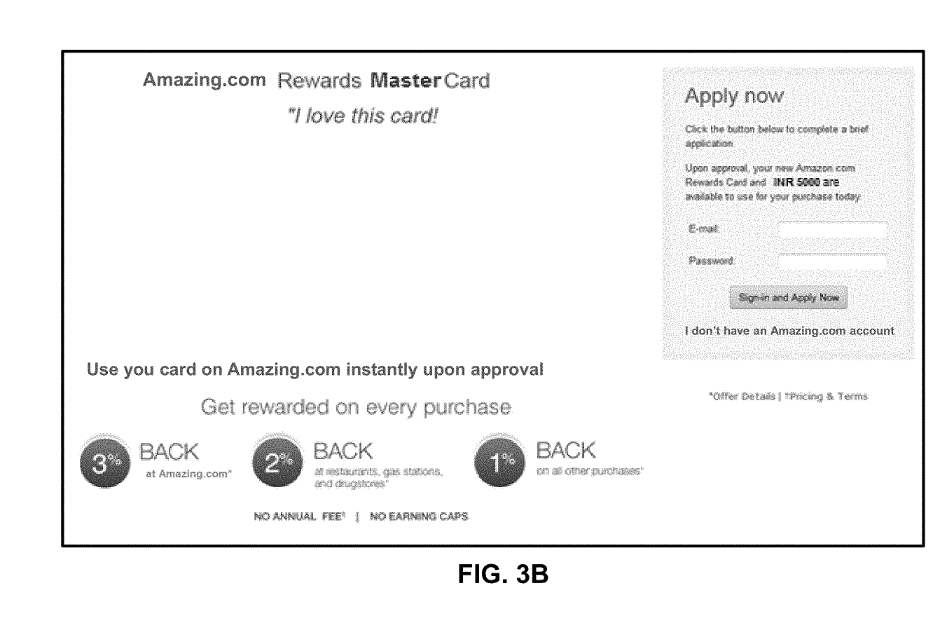

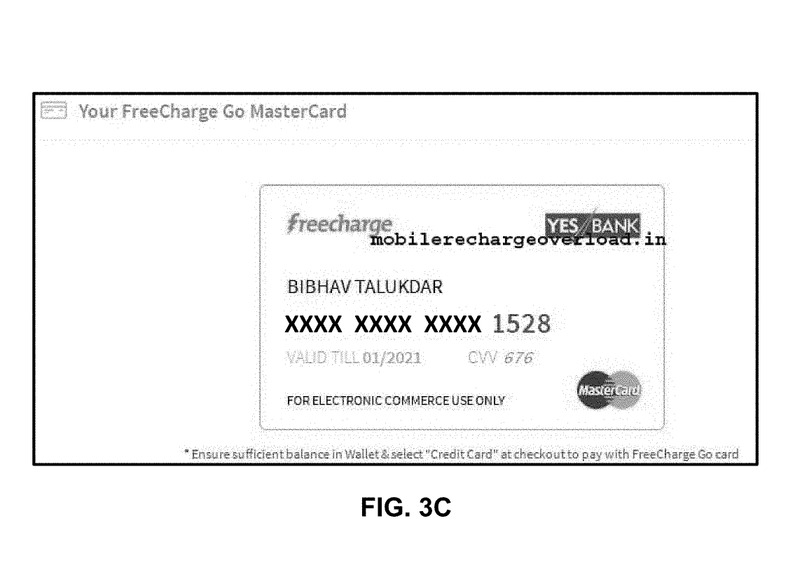

The payment vehicle creation mark may be displayed on the payment page when the consumer is presented with various payment methods to pay for his/her basket. This is shown as an example in FIG. 3A.

In step 208, the creation request is received. The creation request is received at the payment transaction server when the payment vehicle creation mark is selected as the payment option. More details on the creation of the payment vehicle are presented in FIG. 3.

FIG. 3, comprising FIGS. 3A, 3B and 3C, shows an example of performing a purchase transaction in accordance with an embodiment of the invention, wherein FIG. 3A depicts an alternative payment method on a payment screen of a purchase transaction; FIG. 3B depicts a sign-up screen for the alternative payment method; and FIG. 3C depicts a real-time issuance of a payment vehicle for the alternative payment method.

In various embodiments, the payment vehicle for the alternative payment method is a virtual payment card (also referred to herein as a virtual card). For illustrative purposes, the remaining steps of FIG. 3 will be described with reference to a virtual card though it will be appreciated that other payment vehicles (e.g. an overdraw facility or credit account with no linked credit card for accessing credit account funds) can be used as necessary.

As illustrated in FIG. 3A, the consumer may select an option of “Apply for a virtual card now” at a payment screen of the electronic purchase medium, herein represented by an e-commerce platform. The “Apply for a virtual card now” option is an example of the payment vehicle creation mark which may be selected as a payment option. In various embodiments, relating to step 208 above, the creation request is received from the client terminal at the payment transaction server when the payment vehicle creation mark is selected. In some embodiments, selecting the option of “Apply for a virtual card now” activates a pop-up box showing an image of an electronic purchase medium merchant branded card with details of how a virtual card may be issued and used to pay for the pending purchase transaction.

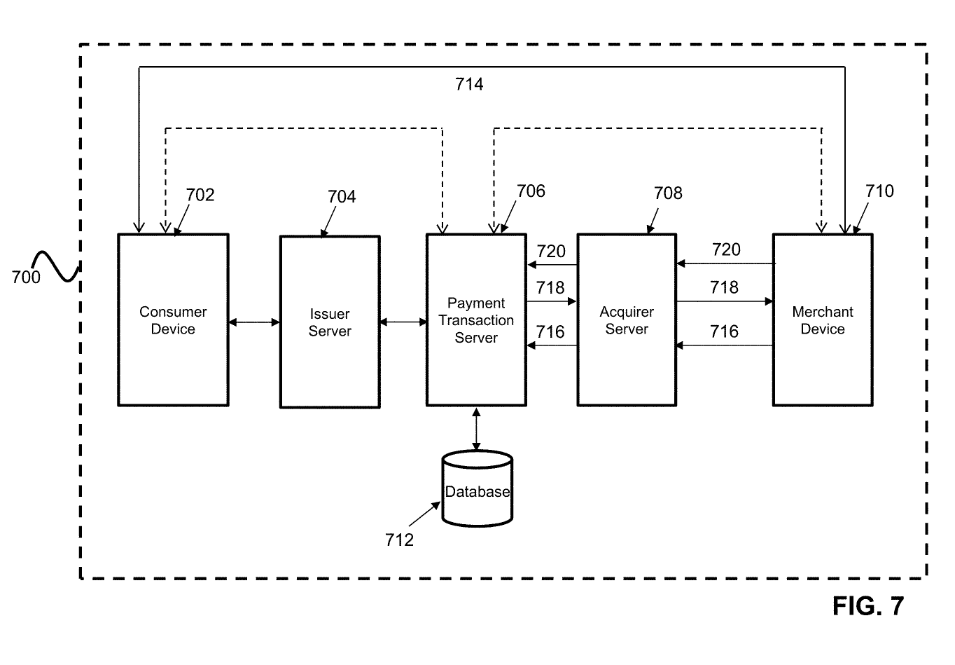

Once the “Apply for a virtual card now” option is selected, the consumer is directed to a sign-up page, to sign-up for the virtual card, as shown in FIG. 3B. In various embodiments, having an account associated with the electronic purchase medium or related website at which the purchase is made is necessary for signing up the virtual card. In these embodiments, the consumer is required either to sign-in to their account or to sign-up for an account before applying for the virtual card. Attractive loyalty programmes may be presented to the consumer at the sign-up page to entice the consumer to sign-up for the virtual card. In this way, the virtual card advantageously provides another avenue for the consumer to benefit from a loyalty program associated with the electronic purchase medium and at the same time, allows the virtual card issuer to increase its customer base. In various embodiments, once the consumer logs-in to his/her account, he/she is presented with a disclaimer or Terms & Conditions (T&Cs) page seeking the consumer's consent to share his/her information with third parties. Upon accepting the T&Cs, the consumer is presented with an application form for the virtual card. The application form may have been partially auto-filled to include at least a name, an address and other contact information associated with the consumer. This information may be automatically retrieved from the consumer's account. The application form may further include additional fields including his/her unique identification number, monthly salary and/or occupation information. The completed application form for the virtual card is then sent from the client terminal to the payment transaction server. Upon receipt of the completed application form, the payment transaction server generates a Primary Account Number (PAN), a Card Verification Code (CVC2) and Expiry date associated with the virtual card. This information is then displayed at the client terminal. If the consumer has an online account with the merchant via which the transaction is being conducted, the details of the virtual card may be stored at the merchant server in association with the consumer's online account. In some embodiments, the virtual card may be a merchant-specific virtual card, such that attempts to use the virtual card for purchases with other online merchants are blocked by the payment transaction server or an issuer server 704 (FIG. 7) with which the payment transaction server is in communication.

In various embodiments, the payment transaction server is configured to identify distinct shopping profiles to be associated with either a credit facility or a pre-paid payment facility to be linked to the virtual card. The identification of shopping profiles and their differentiation may be based on a transaction history of credit card payments and cash-on-delivery payments associated with the consumer account. Therefore, the consumer may not be given control over the type of virtual card for which he/she may apply (e.g. a virtual credit card or a virtual pre-paid card). Rather, the type of virtual card may be determined based on his/her shopping profile. In other embodiments, the consumer is able to select the type of virtual card for which he/she is applying. The options may be presented to the consumer at the point of application for the virtual card.

Once the form is completed and the consumer has selected the desired virtual card type, the virtual card is presented to the consumer as shown in FIG. 3C. The virtual card comprises at least a Primary Account Number (PAN), a Card Verification Code (CVC2) and Expiry date as shown. This information would be required by the consumer to complete his/her purchase. In various embodiments, the virtual card is automatically saved into the consumer account (or into a digital wallet) and placed as the default preferred payment option. The consumer may also choose to change or delete the virtual card after use. Once the virtual card is presented, the consumer is redirected to a checkout screen of the electronic purchase medium to complete the purchase transaction with the standard “one-click” purchase process. This may require inputting of a one-time-password (OTP) that is delivered to his/her registered mobile number for verification, or other security measure.

After signing up for the virtual card, the consumer may choose to abandon or change the basket. If the basket is abandoned, the PAN generated may be retained on file (if it does not correspond to a single-use virtual card) such that it is available for subsequent use for a predetermined period of time. If the virtual card remains inactive during the predetermined period of time, the PAN may be cancelled and will not be usable on the electronic purchase medium anymore. The predetermined period of time may be decided by the issuer issuing the virtual card. In various embodiments, the predetermined period of time is 90 days.

As mentioned above, the virtual card may be confined to the specific electronic purchase medium via which the consumer applied for the card. Alternatively, the virtual card may be activated for use across a range of electronic purchase media, such as e-commerce platforms and mobile apps.

In various embodiments, advertisements and promotions are presented to the consumer at the checkout screen to induce them to convert the virtual card into a standard payment card. A standard payment card may be one that can be used in various electronic purchase medium or physical Point-of-Sale (POS) terminals. Since eligibility for a credit facility or similar has been established in advance of issuing the virtual card, conversion to a physical card may be a single click operation—for example, selection of a button on the checkout screen. The physical card may alternatively be issued automatically, when the card details are provided to the consumer per FIG. 3C.

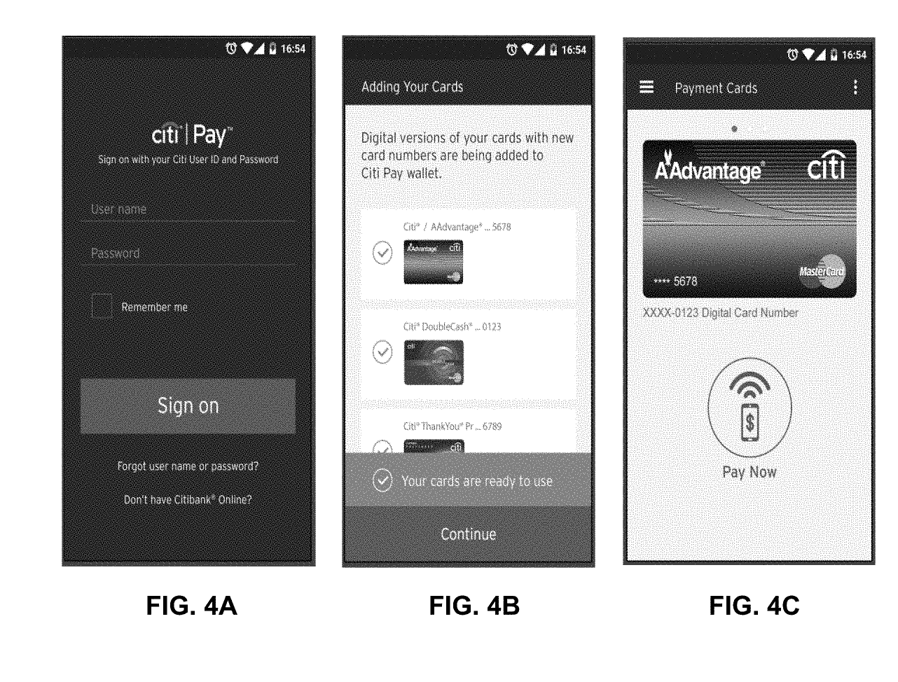

FIG. 4 illustrates an example of adding value to a payment vehicle. This can be used to add value to a virtual pre-paid card, or where a virtual credit card has insufficient value to settle the transaction (note: the virtual credit card may be issued with insufficient value to process the transaction and the consumer may be asked to add the additional value necessary to bring the funds associated with the virtual credit card to an amount equal to or greater than the value of the basket). For illustrative purposes, the processes of FIG. 4 will be described with reference to a virtual pre-paid or stored value card. When a virtual pre-paid card is presented to the consumer in FIG. 3C for use in the purchase transaction, the virtual pre-paid card is required to be topped-up to equal to or greater than the transaction value of the basket. The consumer may be presented a link through which to access an internet banking website or portal, to facilitate topping up the card using a process akin to standard account-to-account funds transfer. The consumer may also be presented with an option to use a virtual wallet (such as Masterpass by Mastercard, or PayPal) to top-up the virtual card. The virtual wallet can be selected through a standard payment mark by which virtual wallets are currently accessed. Selection of that mark results in the consumer being presented a sign-in or sign-up page through which to access or establish a virtual wallet account.

An example of an online payment page used to pay for the virtual pre-paid card is shown in FIG. 4A. The consumer is required to sign in to his/her online banking account. After the consumer is signed in to his/her online banking account, the consumer may find that the virtual pre-paid card has already been included in a list of payment cards that are linked to his/her internet banking account as shown in FIG. 4B. The consumer may then select one of these payment cards to be topped up. In an embodiment, the consumer elects to top-up the virtual pre-paid card. The consumer is then presented with a “pay now” icon as shown in FIG. 4C, which the consumer can select so that funds can be transferred from his/her internet banking account to the virtual pre-paid card. Once the virtual pre-paid card is successfully topped-up, the consumer may go ahead with completing the purchase transaction.

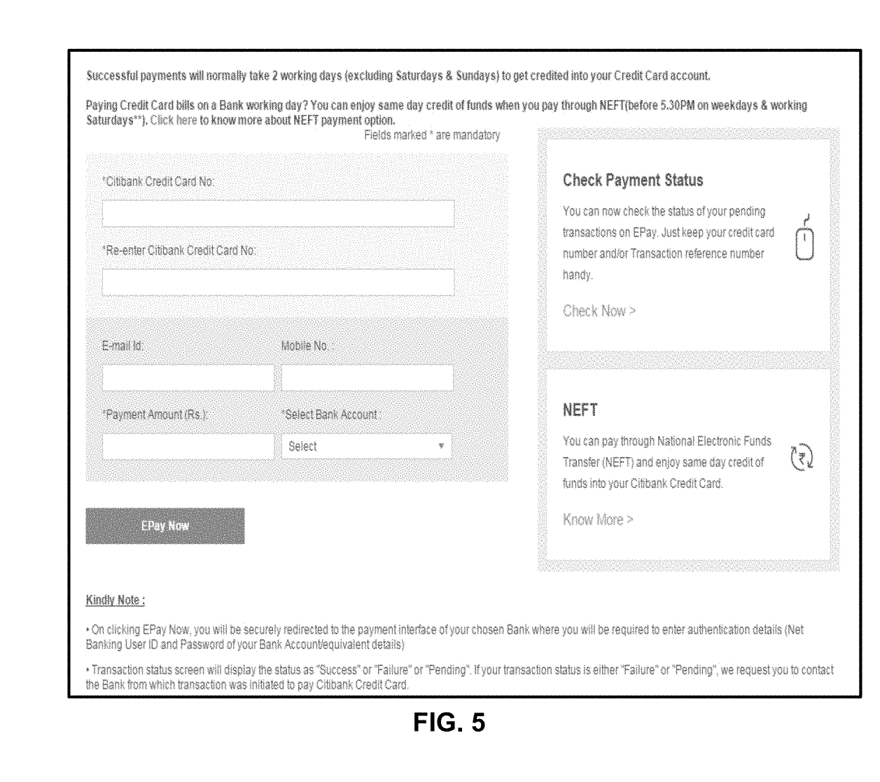

In the scenario where the payment vehicle is a virtual credit card, payment to the virtual credit card can be made in accordance with an embodiment of the invention as depicted in FIG. 5. The credit funds accessible through the virtual credit card may be capped at US$ 100 or any amount as stipulated by the issuer. The virtual credit card may be available for use exclusively on the particular electronic purchase medium (e.g. with the particular merchant or merchant aggregator) providing the online payment page through which the purchase transaction was initiated, and will be declined if used elsewhere.

Once the card is established, the consumer is informed that card information will be available and retrievable on demand through his/her e-commerce account. The card may then function in a similar manner to standard (i.e. physical) credit cards, by which the consumer can make bill payments/top-up through internet banking, receive monthly e-statements, and interact with the card (e.g. check balances and transaction information) through the electronic purchase medium or through a banking or virtual wallet site or app.

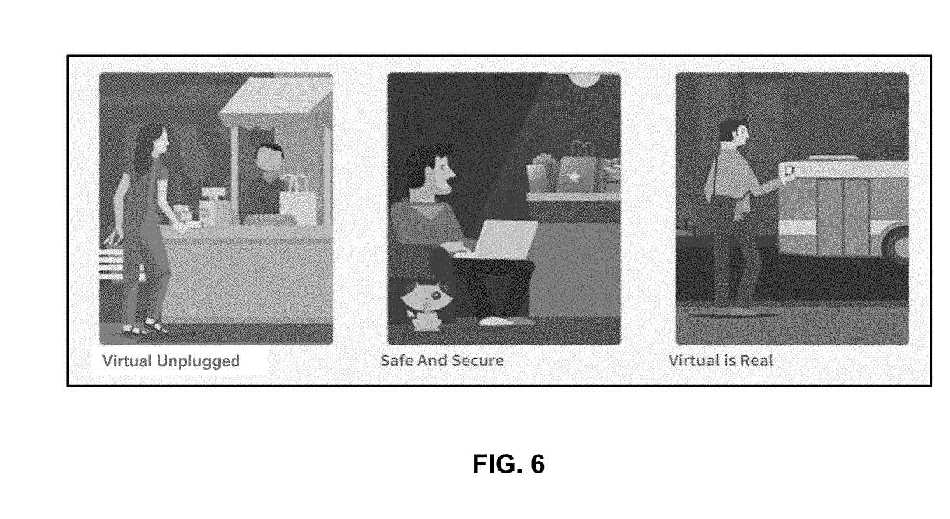

Referring to FIG. 6, examples for using a payment vehicle of the alternative payment method in accordance with an embodiment of the invention are depicted. The virtual card may be converted to a standard credit card easily and efficiently as discussed above. This allows any available balance remaining in the virtual card to be used anywhere. The ease of applying for payment cards online at the time of sale also allows consumers to enjoy a better purchase experience.

Moreover, the payment vehicle issued in the above process is Payment Card Industry Data Security Standard (PCI DSS) compliant. This means that consumers using the payment vehicle can rest assured that they are enjoying the convenience of the payment vehicle while keeping their banking details secure online.

Furthermore, the virtual card functions in the same way as a real payment card for online payments. Consumers may enjoy easy accounting of their monthly expenditures since all relevant transactions may be captured in a monthly statement of the payment card. Still furthermore, merchants benefit by enjoying insurance in transactions since payment card issuers now act as intermediaries for the transactions to ensure that proper payments are made to the merchants. Merchants also operate as acquirers, facilitating distribution of payment vehicles. Overall, the use of a virtual card for purchase transaction aids in improving efficiency of purchase transactions made through electronic purchase media and user experience for consumers and merchants.

FIG. 7 depicts a block diagram of a system or network for processing a purchase transaction in accordance with the embodiment of the invention.

The system 700 comprises a consumer device 702 (a client terminal) in communication with an issuer server 704. The consumer device 702 may also be in direct communication with a payment transaction server 706, without having to communicate with the issuer server 704. In specific embodiments, the consumer device 702 is in direct communication with a merchant device 710, without having to communicate with the issuer server 704 or the payment transaction server 706.

The issuer server 704 is in communication with the payment transaction server 706. The payment transaction server 706 is in communication with an acquirer server 708. The acquirer server 708 is in communication with the merchant device 710. In specific embodiments, the payment transaction server 706 is also in direct communication with the merchant device 710. In either of these circumstances a payment gateway may serve as an intermediary between the merchant's electronic purchase medium (e.g. merchant website/e-commerce platform or mobile app) and merchant's acquirer or payment transaction server. In such cases, the merchant device 710 is considered to incorporate the payment gateway as well as the electronic purchase medium such that relevant requests are forwarded via the payment gateway to the relevant acquirer or payment transaction server.

Use of the term ‘server’ herein can mean a single computing device or a plurality of interconnected computing devices which operate together to perform a particular function. That is, the server may be contained within a single hardware unit or be distributed among several or many different hardware units.

The consumer device 702 typically is associated with a consumer who is a party to a purchase transaction as discussed above. The consumer device 702 may be a fixed (wired) computing device or a wireless (portable) computing device. In specific implementations, the consumer device 702 may be a handheld or portable or mobile device carried or used by the consumer, or may refer to other types of electronic devices such as a personal computer, a land-line telephone or an interactive voice response (IVR) system and the like. The mobile device may be a device, such as a mobile phone, a laptop computer, a personal digital computer (PDA), a mobile computer, a portable music player (such as an iPod™ and the like).

The issuer server 704 is associated with an issuer and may include one or more computing devices that are used to perform a payment transaction. The issuer may be an entity (e.g. a company or organization, such as a bank, a mobile network operator or a retailer) which issues (e.g. establishes, manages, administers) a transaction credential or an account (e.g. a financial bank account). An account, which may also be termed as a consumer bank account, may be associated with a plurality of consumer devices 702. For example, a bank account associated with a virtual card created at the time of purchase may be contained in a digital wallet installed on a mobile device, through an internet banking portal accessible through a personal computer and through the electronic purchase medium through which the virtual card was created.

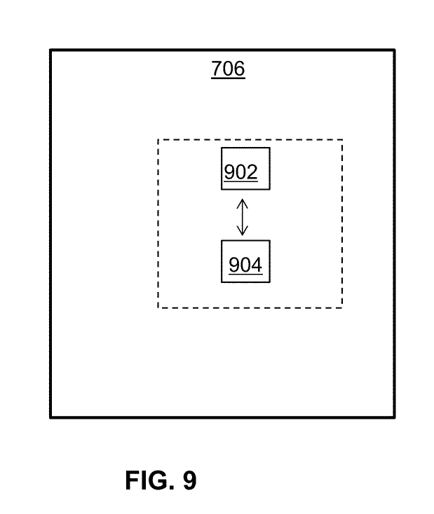

The payment transaction server 706 typically is associated with a payment network. For example, the payment transaction server 706 may be part of the Banknet® network operated by MasterCard®. The payment network (e.g. MasterCard®) operates to process transactions, clear and settle funds for payments between two entities (e.g. two banks). The payment transaction server 706 may include one or more computing devices that are used for processing transactions. An exemplary payment transaction server 706 is shown in FIG. 9.

The acquirer server 708 generally is associated with an acquirer who may be an entity (e.g. a company or organization) which issues (e.g. establishes, manages, administers) a transaction credential or an account (e.g. a financial bank account) of the merchant. An account of the merchant may also be known as a merchant account. Examples of the acquirer include a bank and/or other financial institution. As stated in the above, the acquirer server 708 may include one or more computing devices that are used to establish communication with another server by exchanging messages with and/or passing information to the other server.

The merchant device 710 typically is associated with a merchant who is also a party to the purchase transaction. The merchant device 710 may be a point-of-sale (POS) terminal, an automatic teller machine (ATM), a personal computer, a computer server (hosting a website, for example), an IVR system, a land-line telephone, or any type of mobile device such as a mobile phone, a personal digital assistant (PDA), a laptop computer, a tablet computer and the like.

The payment transaction server 706 may be configured to communicate with, or may include, a database 712. The database 712 stores purchase transaction data. Examples of purchase transaction data include Transaction ID, Merchant ID, Consumer Name, Merchant Name, Merchant Country, Merchant Address, Merchant Postal Code. Data (“Merchant name” or “Merchant ID”) relating to the merchant, time and date for which the goods/services relating to the transaction will be delivered may also be included in the database 712. In some embodiments, the data also include consumer data which identify a consumer account, and merchant data which identify a merchant account. In some embodiments, the consumer account and the merchant account are associated with corresponding accounts in the issuer server and the acquirer server respectively. Purchase transaction data may also include information relating to the consumer account associated with the electronic purchase medium. In some embodiments, the data also comprise transaction history of the consumer and the merchant, and/or financial history of the consumer. The financial history may relate to a credit history of repayments as well as mode of payments for past transactions associated with the consumer.

In a preferred embodiment, the consumer device 702 is capable of wireless communication using a suitable protocol. In some embodiments, the wireless communication comprises established telecommunication known in the art such as GSM, CDMA, WIFI or the like. In some embodiments, the wireless communication is established through the Internet via a website associated with the merchant device 710. It will be appreciated by a person skilled in the art that depending on the wireless communication protocol used, appropriate handshaking procedures may need to be carried out to establish communication between the consumer device 702 and the merchant device 710.

In an example for processing a purchase transaction through an electronic purchase medium, a message 714 comprising a basket and a creation request to create a payment vehicle is generated at a client terminal. Generally, the client terminal may be associated with the consumer device 702 where the consumer can select items to be included in the basket on the electronic purchase medium. In various embodiments, the consumer has a registered account with the electronic purchase medium. The consumer may also be a registered user of an account issued by a bank or financial institution and maintained at an issuer server 704. In the preferred embodiment, the consumer possesses a shopping profile which conforms to the predetermined shopping profile as discussed in the process of FIG. 2. The consumer may then be presented with an option to select “Apply for a virtual card now” as shown in FIG. 3A to proceed with including a creation request to create a virtual card for the processing of the purchase transaction. In other embodiments, the option to select “Apply for a virtual card now” may be presented to all consumers associated with, or making purchases through, the electronic purchase medium. In this case, the determination of whether the consumer is authorized to be issued the alternative payment vehicle, for example, the virtual card, may be carried out at the payment transaction server 706 in later processes. The necessary information is comprised in the message 714 which is sent from the client terminal to the merchant device 710, where the merchant device 710 hosts the electronic purchase medium (e.g. e-commerce platform or mobile app). In various embodiments, the message 714 is generated by the consumer once the consumer has generated the basket and selected “Apply for a virtual card now” to create a virtual card as discussed in an example depicted in FIG. 3A.

In response to the message 714, the merchant device 710 then forwards the necessary information in a forward message 716 to the payment transaction server 706 and/or the acquirer server 708. The merchant device 710 may be configured to extract the necessary information to be forwarded to the payment transaction server 706 and/or the acquirer server 708 for the creation of the virtual card. The forward message 716 includes at least unique identification information of the consumer purchasing the basket, a transaction value of the basket and the creation request. In other embodiments, the merchant device 710 sends a request to the consumer device to provide more information for the creation of the virtual card. This may be in the form of filling up an application form such as in the example discussed with reference to FIG. 3B. A reply message may in turn be sent from the consumer device 702 and received by the merchant device 710, where the reply message comprises at least the information required in the application form for signing up for the virtual card. This may include at least a name, an address and contact information associated with the consumer, and additional information comprising the consumer's unique identification number, monthly salary and/or occupation information. The information received in the application form may then be compiled and sent to the payment transaction server 706 in the forward message 716.

After the forward message 716 is received at the payment transaction server 706, the payment transaction server 706 determines whether the consumer is authorized to be issued a payment vehicle based at least on the unique consumer identification information. In embodiments where the creation mark is presented to only a selected group of consumers associated with the electronic payment medium, the selected group of consumers may have already been pre-authorized. In any case, if authorization is given to issue the consumer a payment vehicle, the payment vehicle is created in response to the creation request and will have an available balance equal to or higher than the transaction value. In various embodiments, in determining whether the consumer is authorized to be issued a payment vehicle, the payment transaction server 706 determines whether a financial history of the consumer conforms to an authorization profile, the financial history being identified based on the unique consumer identification information. The financial history of the consumer may be retrieved from the database 712. In various embodiments, based on the financial history of the consumer, the payment transaction server 706 is configured to identify distinct shopping profiles to be associated with either a credit facility or a pre-paid payment facility to be associated with the payment vehicle. Issuance of the payment vehicle to the consumer is then authorized in response to a determination that his/her financial history conforms to the authorization profile, where the authorization profile may determine if the payment vehicle to be issued is associated with a credit facility or a pre-paid payment facility. In various embodiments, the payment vehicle includes a virtual pre-paid card, or a virtual credit card. In various embodiments, the authorization profile is determined by the payment transaction server 706.

Once the payment vehicle has been created, a payment vehicle detail message 718 may be sent from the payment transaction server 706 to the merchant device 710 and/or the consumer device 702. The payment vehicle detail message 718 comprises details of the payment vehicle generated, and may include at least a Primary Account Number (PAN), a Card Verification Code (CVC2) and Expiry date of the payment vehicle. The consumer may then use the details of the payment vehicle to complete the purchase transaction of the basket for purchase on the electronic payment medium. Alternatively, once the payment vehicle has been created, the payment transaction server 706 may automatically complete the purchase transaction of the basket without further input from the consumer.

In embodiments where the consumer is presented with the details of the payment vehicle, the consumer completes the purchase transaction of the basket once the consumer is satisfied with the order. The consumer may then submit a completion request 720 to the payment transaction server 706, either directly or via the acquirer server 708. The completion request 720 may be sent out by the consumer device 702 via the electronic payment medium at the merchant device 710. Once the completion request 720 is received, settlement for the transaction may be initiated. It will be appreciated by the person skilled in the art that the transaction may then be completed in a standard way involving a state-of-the-art four parties system as shown in FIG. 7.

The computer/server 706 may comprise: at least one processor; and at least one memory including computer program code; the at least one memory and the computer program code configured to, with at least one processor, cause the computer/server at least to: (A) receive, from a client terminal a basket and a creation request to create a payment vehicle for initiating the purchase transaction, the purchase transaction being for purchasing the basket; (B) receive unique consumer identification information of a consumer purchasing the basket, a transaction value of the basket and the creation request; (C) determine whether the consumer is authorized to be issued a payment vehicle based at least on the unique consumer identification information; and if the consumer is so authorized, (D) create the payment vehicle in response to the creation request, the payment vehicle having an available balance equal to or higher than the transaction value; and (E) process the purchase transaction using the payment vehicle.

Step (C) may be performed by determining whether a financial history of the consumer conforms to an authorization profile, the financial history being identified based on the unique consumer identification information; and authorizing issuance of the payment vehicle to the consumer if the financial history conforms to the authorization profile. Step (C) may also be performed by determining a maximum payment vehicle balance for which the consumer can be authorized, and wherein creating the payment vehicle comprises creating the payment vehicle with the maximum payment vehicle balance, if the maximum payment vehicle balance is equal to or higher than the transaction value. Moreover, step (C) may be performed by determining a maximum payment vehicle balance for which the consumer can be authorized, and wherein step (D) may also be performed by sending a request to the client terminal, the request requesting provision of a consumer specified payment vehicle balance greater than or equal to the transaction value and less than or equal to the maximum payment vehicle balance; receiving the consumer specified payment vehicle balance; and creating the payment vehicle with the consumer specified payment vehicle balance.

Step (D) may be performed by receiving from the client terminal a top-up request to increase the available balance of the payment vehicle to equal to or higher than the transaction value, using funds drawn from an account associated with the consumer; and creating the payment vehicle with the increased available balance.

Step (E) may be performed by automatically processing the transaction upon creation of the payment vehicle based the transaction value, the unique consumer identification information and the payment vehicle. Step (E) may also be performed by sending to the client terminal payment vehicle details; and receiving from the client terminal a completion request to complete the transaction using the payment vehicle and based on the transaction value and the unique consumer identification information.

In an implementation, the computer/server 706 may be further caused to: (F) receive a checkout request and the unique consumer identification information; and (G) identify based on the unique consumer identification information, a shopping profile associated with the unique consumer identification information; and (H) display a payment vehicle creation mark on the client terminal if the shopping profile conforms to a predetermined shopping profile for which a payment vehicle can be created, wherein step (A) in receiving the creation request further comprises receiving a selection of the payment vehicle creation mark.

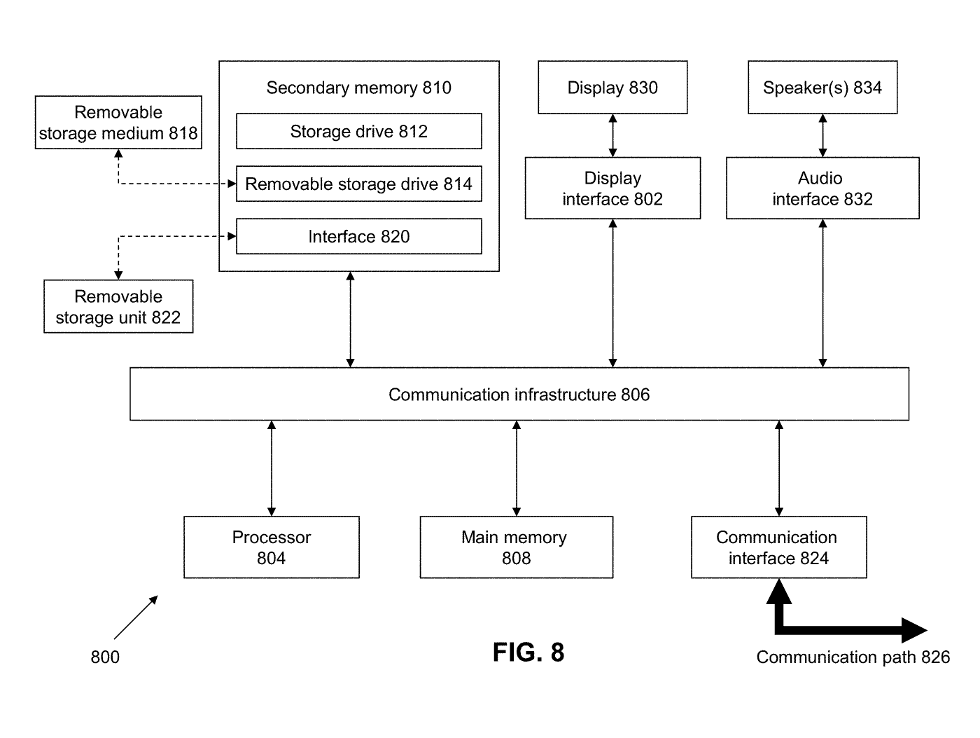

FIG. 8 depicts an exemplary computer/computing device 800, hereinafter interchangeably referred to as a computer system 800, where one or more such computing devices 800 may be used to facilitate execution of the above-described computer process for completing a transaction using a favourites list. In addition, one or more components of the computer system 800 may be used to realize the server/computer 706. The following description of the computing device 800 is provided by way of example only and is not intended to be limiting.

As shown in FIG. 8, the example computing device 800 includes a processor 804 for executing software routines. Although a single processor is shown for the sake of clarity, the computing device 800 may also include a multi-processor system. The processor 804 is connected to a communication infrastructure 806 for communication with other components of the computing device 800. The communication infrastructure 806 may include, for example, a communications bus, cross-bar, or network.

The computing device 800 further includes a main memory 808, such as a random access memory (RAM), and a secondary memory 810. The secondary memory 810 may include, for example, a storage drive 812, which may be a hard disk drive, a solid state drive or a hybrid drive and/or a removable storage drive 814, which may include a magnetic tape drive, an optical disk drive, a solid state storage drive (such as a USB flash drive, a flash memory device, a solid state drive or a memory card), or the like. The removable storage drive 814 reads from and/or writes to a removable storage medium 818 in a well-known manner. The removable storage medium 818 may include magnetic tape, optical disk, non-volatile memory storage medium, or the like, which is read by and written to by removable storage drive 814. As will be appreciated by persons skilled in the relevant art(s), the removable storage medium 818 includes a computer readable storage medium having stored therein computer executable program code instructions and/or data.

In an alternative implementation, the secondary memory 810 may additionally or alternatively include other similar means for allowing computer programs or other instructions to be loaded into the computing device 800. Such means can include, for example, a removable storage unit 822 and an interface 820. Examples of a removable storage unit 822 and interface 820 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 822 and interfaces 820 which allow software and data to be transferred from the removable storage unit 822 to the computer system 800.

The computing device 800 also includes at least one communication interface 824. The communication interface 824 allows software and data to be transferred between computing device 800 and external devices via a communication path 826. In various embodiments of the inventions, the communication interface 824 permits data to be transferred between the computing device 800 and a data communication network, such as a public data or private data communication network. The communication interface 824 may be used to exchange data between different computing devices 800 which such computing devices 800 form part of an interconnected computer network. Examples of a communication interface 824 can include a modem, a network interface (such as an Ethernet card), a communication port (such as a serial, parallel, printer, GPIB, IEEE 1393, RJ45, USB), an antenna with associated circuitry and the like. The communication interface 824 may be wired or may be wireless. Software and data transferred via the communication interface 824 are in the form of signals which can be electronic, electromagnetic, optical or other signals capable of being received by communication interface 824. These signals are provided to the communication interface via the communication path 826.

As shown in FIG. 8, the computing device 800 further includes a display interface 802 which performs operations for rendering images to an associated display 830 and an audio interface 832 for performing operations for playing audio content via associated speaker(s) 834.

As used herein, the term “computer program product” may refer, in part, to removable storage medium 818, removable storage unit 822, a hard disk installed in storage drive 812, or a carrier wave carrying software over communication path 826 (wireless link or cable) to communication interface 824. Computer readable storage media refers to any non-transitory, non-volatile tangible storage medium that provides recorded instructions and/or data to the computing device 800 for execution and/or processing. Examples of such storage media include magnetic tape, CD-ROM, DVD, Blu-ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a SD card and the like, whether or not such devices are internal or external of the computing device 800. Examples of transitory or non-tangible computer readable transmission media that may also participate in the provision of software, application programs, instructions and/or data to the computing device 800 include radio or infra-red transmission channels as well as a network connection to another computer or networked device, and the Internet or Intranets including e-mail transmissions and information recorded on Websites and the like.

The computer programs (also called computer program code) are stored in main memory 808 and/or secondary memory 810. Computer programs can also be received via the communication interface 824. Such computer programs, when executed, enable the computing device 800 to perform one or more features of embodiments discussed herein. In various embodiments, the computer programs, when executed, enable the processor 804 to perform features of the above-described embodiments. Accordingly, such computer programs represent controllers of the computer system 800.

Software may be stored in a computer program product and loaded into the computing device 800 using the removable storage drive 814, the storage drive 812, or the interface 820. Alternatively, the computer program product may be downloaded to the computer system 800 over the communications path 826. The software, when executed by the processor 804, causes the computing device 800 to perform functions of embodiments described herein.

It is to be understood that the embodiment of FIG. 8 is presented merely by way of example. Therefore, in some embodiments one or more features of the computing device 800 are omitted. Also, in some embodiments, one or more features of the computing device 800 can be combined together. Additionally, in some embodiments, one or more features of the computing device 800 can be split into one or more component parts.

It will be appreciated that the elements illustrated in FIG. 8 function to provide means for performing the computer process as described with respect to FIG. 1. For example, the computing device 800 provides an apparatus for processing a purchase transaction, the apparatus comprising: at least one processor 804, at least one memory 808 including computer program code and at least one communication interface 824.

In an implementation, the server 706 may be generally described as a physical device comprising at least one processor 902 and at least one memory 904 including computer program code. The at least one memory 904 and the computer program code are configured to, with the at least one processor 902, cause the physical device to perform the operations described in FIG. 1. An example of the server 706 is shown in FIG. 9.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. An apparatus for processing a purchase transaction, the apparatus comprising:
at least one processor; and
at least one memory including computer program code;
the at least one memory and the computer program code configured to, with the at least one processor, cause the apparatus at least to:
receive, from a client terminal:
data representing a basket for purchase; and
a creation request to create a payment vehicle for initiating the purchase transaction based on the data representing the basket;
receive:
unique consumer identification information of a consumer purchasing the basket;
a transaction value of the basket; and
the creation request;
determine whether the consumer is authorized to be issued a payment vehicle based at least on the unique consumer identification information and, in response to a determination that the consumer is so authorized, create the payment vehicle in response to the creation request, the payment vehicle having an available balance equal to or higher than the transaction value; and
process the purchase transaction using the payment vehicle.

2. The apparatus of claim 1, wherein the at least one memory and the computer program code is configured to cause the apparatus to:
determine whether a financial history of the consumer conforms to an authorization profile, the financial history being identified based on the unique consumer identification information; and
authorize issuance of the payment vehicle to the consumer in response to a determination that the financial history conforms to the authorization profile.

3. The apparatus of claim 1, wherein the at least one memory and the computer program code is configured to cause the apparatus to:
determine a maximum payment vehicle balance for which the consumer can be authorized, and wherein creating the payment vehicle comprises creating the payment vehicle with the maximum payment vehicle balance, in response to a determination that the maximum payment vehicle balance is equal to or higher than the transaction value.

4. The apparatus of claim 1, wherein the at least one memory and the computer program code is configured to cause the apparatus to:
determine a maximum payment vehicle balance for which the consumer can be authorized;
send a request to the client terminal, the request requesting provision of a consumer specified payment vehicle balance greater than or equal to the transaction value and less than or equal to the maximum payment vehicle balance;
receive the consumer specified payment vehicle balance; and
create the payment vehicle with the consumer specified payment vehicle balance.

5. The apparatus of claim 1, wherein the at least one memory and the computer program code is configured to cause the apparatus to:
receive from the client terminal a top-up request to increase the available balance of the payment vehicle to equal to or higher than the transaction value, using funds drawn from an account associated with the consumer; and
create the payment vehicle with the increased available balance.

6. The apparatus of claim 1, wherein the at least one memory and the computer program code is configured to cause the apparatus to:
automatically process the transaction upon creation of the payment vehicle based the transaction value, the unique consumer identification information and the payment vehicle.

7. The apparatus of claim 1, wherein the at least one memory and the computer program code is configured with the at least one processor to cause the apparatus to:
send to the client terminal payment vehicle details; and
receive from the client terminal a completion request to complete the transaction using the payment vehicle and based on the transaction value and the unique consumer identification information.

8. The apparatus of claim 1, wherein the at least one memory and the computer program code is further configured to cause the apparatus to:
receive:
a checkout request; and
the unique consumer identification information;
identify based on the unique consumer identification information, a shopping profile associated with the unique consumer identification information;
cause the client terminal to display a payment vehicle creation mark if the shopping profile conforms to a predetermined shopping profile for which a payment vehicle can be created, and
receive a selection of the payment vehicle creation mark.

9. A computer process for accessing funds for a purchase transaction, comprising:
receiving, from a client terminal, at a merchant server:
data representing a basket for purchase; and
a creation request to create a payment vehicle for initiating the purchase transaction to purchase the basket;
receiving, at a payment transaction server:
unique consumer identification information of a consumer purchasing the basket;
a transaction value of the basket; and
the creation request;
determining, at the payment transaction server, whether the consumer is authorized to be issued a payment vehicle based at least on the unique consumer identification information and, in response to a determination that the consumer is so authorized, creating the payment vehicle in response to the creation request, the payment vehicle having an available balance equal to or higher than the transaction value; and
processing the purchase transaction using the payment vehicle.

10. The computer process of claim 9, wherein the determining step comprises:
determining, at the payment transaction server, whether a financial history of the consumer conforms to an authorization profile, the financial history being identified based on the unique consumer identification information; and
authorising issuance of the payment vehicle to the consumer in response to a determination that the financial history conforms to the authorization profile.

11. The computer process of claim 9, wherein the determining step comprises:
determining, at the payment transaction server, a maximum payment vehicle balance for which the consumer can be authorized, and wherein creating the payment vehicle comprises creating the payment vehicle with the maximum payment vehicle balance, in response to a determination that the maximum payment vehicle balance is equal to or higher than the transaction value.

12. The computer process of claim 9, wherein the determining step comprises:
determining, at the payment transaction server, a maximum payment vehicle balance for which the consumer can be authorized, and wherein creating the payment vehicle comprises:
sending a request from the payment transaction server to the client terminal, the request requesting provision of a consumer specified payment vehicle balance greater than or equal to the transaction value and less than or equal to the maximum payment vehicle balance;
receiving the consumer specified payment vehicle balance; and
creating the payment vehicle with the consumer specified payment vehicle balance.

13. The computer process of claim 9, wherein the creating step comprises:
receiving, from the client terminal and at the payment transaction server, a top-up request to increase the available balance of the payment vehicle to equal to or higher than the transaction value, using funds drawn from an account associated with the consumer; and
creating the payment vehicle with the increased available balance.

14. The computer process of claim 9, wherein the processing step further comprises:
automatically processing the transaction upon creation of the payment vehicle based the transaction value, the unique consumer identification information and the payment vehicle.

15. The computer process of claim 9, wherein the processing step further comprises:
sending, by the payment transaction server to the client terminal, payment vehicle details; and
receiving, from the client terminal at the payment transaction server, a completion request to complete the transaction using the payment vehicle and based on the transaction value and the unique consumer identification information.

16. The computer process of claim 9, wherein the processing step further comprises:
sending a notification to the client terminal, the notification indicating that processing of the purchase transaction has been successful.

17. The computer process of claim 9, further comprising:
receiving at the merchant terminal:
a checkout request; and
the unique consumer identification information;
identifying, at the payment transaction server and based on the unique consumer identification information, a shopping profile associated with the unique consumer identification information; and
displaying a payment vehicle creation mark on the client terminal if the shopping profile conforms to a predetermined shopping profile for which a payment vehicle can be created, and wherein
receiving a creation request comprises receiving a selection of the payment vehicle creation mark.

18. The computer process of claim 9, further comprising terminating the payment vehicle after a predetermined expiry period from a time of creation of the payment vehicle.

19. The computer process of claim 18, comprising terminating the payment vehicle after the predetermined expiry period if the processing step does not occur within the predetermined expiry period.

20. The computer process of claim 9, further comprising receiving, after the processing step, a top-up request to increase the available balance of the payment vehicle using funds drawn from an account associated with the consumer.
